(19) United States
(12) Patent Application Publication
(10) Pub. No.: US 2022/0101088 A1
(43) Pub. Date: Mar. 31, 2022

(54) TRAINING NEURAL NETWORKS FOR AN EFFICIENT IMPLEMENTATION ON HARDWARE

(71) Applicant: Robert Bosch GmbH, Stuttgart (DE)

(72) Inventors: Falk Heuer, Dormagen (DE); Alexander Lengsfeld, Hildesheim (DE); Philip Lenz, Holle (DE)

(21) Appl. No.: 17/429,094

(22) PCT Filed: Feb. 17, 2020
(86) PCT No.: PCT/EP2020/054054

§ 371 Date: Aug. 6, 2021

(30) Foreign Application Priority Data
Mar. 1, 2019 (DE) 102019202816.0

(51) Int. Cl. G06N 3/04

(52) U.S. Cl. CPC G06N 3/04

(57) ABSTRACT

A method for training an artificial neural network (ANN), which has a multitude of neurons. In the method, a measure of the quality is ascertained that the ANN has achieved overall within a time period in the past; one or more neurons are evaluated based on a measure of their respective quantitative contributions to the ascertained quality; measures by which the evaluated neurons are trained in the further course of the training and/or significance values of these neurons in the ANN are specified based on the evaluations of the neurons. A method is also described in which an arithmetic unit is selected which has hardware resources for a predefined number of neurons, layers of neurons and/or connections between neurons, and a model of the ANN is selected whose number of neurons, layers of neurons and/or connections between neurons exceeds the predefined number.

### FIELD

The present invention relates to the training of neural networks with the goal of allowing these neural networks to be implemented on hardware in an efficient manner such as for use onboard vehicles.

### BACKGROUND INFORMATION

An artificial neural network, ANN, includes an input layer, multiple processing layers and an output layer. Input variables are read into the ANN at the input layer and, on their path through the processing layers to the output layer, are processed with the aid of a processing chain, which is parameterized as a rule. During training of the ANN, the particular values for the parameters of the processing chain are ascertained and used by the processing chain to optimally map a set of learning values for the input variables to an associated set of learning values for the output variables.

The strength of ANNs is their capability to massively process, in parallel, very highly dimensioned data such as high-resolution images. The price to be paid for this parallel processing is a high hardware outlay for the implementation of an ANN. Typically, graphics processing units (GPUs) having a large memory capacity are required. Based on the recognition that a large portion of the neurons in a deep ANN provide little or no contribution to the final result supplied by the ANN, U.S. Pat. No. 5,636,326 describes subjecting the weights of connections between neurons in the fully trained ANN to a selection process (“pruning”). This makes it possible to greatly reduce the number of connections and neurons without any significant loss in accuracy.

### DETAILED DESCRIPTION OF EXAMPLE EMBODIMENTS

Within the framework of the present invention, a method for training an artificial neural network (ANN) is provided. The goal is to allow for an efficient implementation of the ANN on hardware. ‘Efficient’ in this context may mean, for example, that the ANN manages with a limited configuration of hardware resources. However, ‘efficient’ can also mean that the network architecture and/or the neurons in one or more layers of the ANN is/are optimally used and/or utilized to capacity. The precise definition of ‘efficient’ consequently results from the specific application in which the ANN is used.

In the present method, in accordance with an example embodiment of the present invention, at any instant during the training that may be performed in any conventional manner in all other respects, a measure of the quality is ascertained that the ANN has achieved overall within a time period in the past. For instance, the quality may encompass a training progress, a capacity utilization of the neurons of a layer or another subregion of the ANN, a capacity utilization of the neurons of the ANN overall, and also any combinations thereof such as weighted combinations. The precise definition of ‘quality’ thus also results from the concrete application.

As a result, the measure of the quality, for example, may include a measure of the training progress of the ANN, a measure of the capacity utilization of the neurons of a layer or of another subregion of the ANN, and/or a measure of the capacity utilization of the neurons of the ANN as a whole.

One or more neurons are evaluated based on a measure of their respective quantitative contributions to the ascertained quality. Measures by which the evaluated neurons are trained in the further course of the training and/or significance values of these neurons in the ANN are specified based on the evaluation of the neurons. These measures may then be implemented in the further training course. The specified significance values of the neurons in the ANN may also continue to be valid for the inference phase, i.e., for the later productive operation of the ANN following the training.

In particular, for instance, the measure of the quality may be evaluated as a weighted or unweighted sum of quantitative contributions of individual neurons.

It was recognized that this makes it possible already during the training to take into account the preference of optimally using the neurons of the ANN as well as the connections between these neurons to their full capacity. This desire, for instance, may culminate in an optimization goal for the training of the ANN. Should it turn out during the training that certain neurons or connections between neurons are not optimally utilized to their full capacity despite the explicit preference, then these neurons or connections are able to be deactivated already during the training. This has different advantages over retroactive “pruning” once the training has been concluded.

In the event that it turns out even at an early stage during the training that certain neurons or connections between neurons are less relevant, then these neurons and/or connections are able to be deactivated early on. No further computational work arises for these neurons or connections during the training from this point onward. It was recognized that a price had to be paid for any final deactivation or removal of a neuron or a connection, in the form of the computational effort already invested in the training of this neuron or connection. Starting with the deactivation or removal, the findings from this training embodied in this neuron or in this connection are no longer used, i.e., the already invested work is discarded. The amount of this work is advantageously reduced, similar to the practice in the academic or professional education field of removing candidates unsuited to the field as early as possible. The desired end result, i.e., a fully trained ANN that is simultaneously restricted to the actually relevant neurons and connections, may thus be obtained relatively quickly.

The restriction to the actually relevant neurons and connections in turn is important for the efficient implementation of the fully trained ANN on hardware. In particular, when using ANNs in control units for vehicles such as for driver assistance systems or systems for the at least partly automated driving, the specification regarding the available hardware is frequently already firmly established before the training of the ANN is started. The finished ANN is then limited to these given hardware resources in terms of its size and complexity. At the same time, it must manage with these hardware resources in the inference, i.e., the evaluation of input variables in the live operation in order to supply the queried output variables within the response time specified for the respective application. Each deactivated neuron and each deactivated connection saves computational work and thus response time in every further inference.

The deactivation of neurons or connections basically constitutes an intervention in the ANN. Carrying out this intervention during the ongoing training process makes it possible for the training process to react to the intervention. Side effects of the intervention such as overfitting to the training data, a worse generalization of the ANN to unknown situations or greater susceptibility to a manipulation of the inference by the presentation of an adversarial example are able to be considerably reduced in this way. In contrast to the random deactivation of a certain percentage of the neurons during training (“random dropout”), for example, this does not entail the permanent non-utilization of a portion of the learned information that corresponds to this percentage. The reason is that, from the start, the deactivation of the neurons or connections is motivated by the lack of relevance of the particular neurons or connections for the quality.

Finally, the circle of possible measures that may be taken in response to a lower quantitative contribution of certain neurons to the quality is expanded beyond the mere deactivation of these neurons. For example, the further training may selectively focus on such “weak” neurons so that they may possibly still provide a productive contribution to the quality after all. This is comparable to the frequent use of tutoring as the first measure in the school environment for problems in a certain subject instead of immediately questioning the talent of a student for this subject.

The past time period advantageously includes at least one epoch of the training, i.e., a time period during which every one of the available learning datasets, which include learning values for the input variables and associated learning values for the output variables, was used at least once. The ascertained quantitative contributions of the neurons to the quality are then more easily comparable. For example, it is by all means possible that certain neurons of the ANN are “specialized” toward a good handling of certain situations that occur in the input variables, i.e., that these situations “suit” these neurons particularly well. If a time period in which these situations predominantly arise is examined, then the output of these neurons is evaluated higher than it is in reality because in other situations, the output of other neurons may be considerably better. Similar to academic training, this corresponds to an exam for which the candidate has selectively prepared for a certain subfield of the test material and “is lucky” insofar as precisely this subfield is selectively examined. The evaluation then puts at a disadvantage the other candidates whose knowledge is less detailed in its depth but much better covers the entire spectrum of the test material. The consideration of at least one epoch corresponds to a fairer examination with broadly varying questions from the complete spectrum of the test material.

In one particularly advantageous embodiment of the present invention, a change of a cost function (loss function), to the optimization of which the training of the ANN is directed, over the past time period is taken into account in the measure of the quality. This ensures that the measures that are taken in response to the evaluation of the neurons are not in contradiction with the goal that is ultimately pursued by the training of the ANN.

In a further, particularly advantageous embodiment, quantitative contributions of neurons to the quality are weighted proportionately more highly the more recently in time these contributions were rendered. This makes it possible to take into account that knowledge learned by the ANN may age, like any other knowledge, so that new knowledge has to take its place.

For example, if—starting from a current iteration step t—a time period is examined that reaches back N iteration steps, then the total quantitative contributions that a layer k of the ANN has made to the quality of the ANN overall during this period, such as an iteration progress, is able to be cumulated and/or aggregated. In the process, it can be taken into account, in particular also via a dropout tensor Dₜ₋ₙ^{k}, which neurons in layer k were actually active during a given iteration step t-n. For instance, for a fully networked layer k of the ANN, the contributions to the quality of the respective active neurons are able to be combined across all past N iteration steps in an “activation quality” Mₜ^{k}, which can be written in the following way, for example:

$${M}_{t}^{k} = n o r m ( {\sum }_{n = 0}^{N} {γ}^{n} ( Δ {L}_{t - n} \cdot {D}_{t - n}^{k} ) / {\sum }_{n = 0}^{N} {γ}^{n} ) .$$

Mₜ^{k} includes the corresponding quality of all individual neurons in layer k and depends on time step t.

In this case, L is the cost function (loss function). Accordingly, ΔLₜ₋ₙ is the difference of the cost function between time step t-n and time step t. Expiration parameter y standardizes the effects of the iterations steps that took place at different points in the past. Dropout tensor Dₜ₋ₙ^{k} indicates for each layer k of the ANN and for each iteration step t-n which neurons of layer k were or were not active in iteration step t-n in each case. Thus, Dₜ₋ₙ^{k} is used to take into account a possible temporary deactivation of individual neurons for individual iteration steps (dropout). The use of a dropout when training the ANN is not mandatory.

Depending on the type of layer k, Mₜ^{k} and/or Dₜ₋ₙ^{k} may be vectors or matrices.

The described “activation quality” Mₜ^{k} may alternatively also be expressed as a function of signals Sₜ^{k} and weights Θₜ^{k} for all neurons of layer k. In the broadest sense, signals Sₜ^{k} are activations of the neurons such as sums of inputs weighted by weights Θₜ^{k} that are conveyed to the respective neurons. Mₜ^{k} is then able to be written with Sₜ^{k=1}=xₜ as

$${M}_{t}^{k} = n o r m ( {\sum }_{n = 0}^{N} {γ}^{n} ( {S}_{t}^{k - 1} {Θ}_{t}^{k} ) ) .$$

In this context, xₜ denotes the inputs that are conveyed to the ANN as a whole.

In every iteration step, the weights that are allocated to neurons in the ANN are changed by specific amounts according to stipulations of the cost function and the used training strategy (such as a stochastic gradient descent, SGD). In a further, particularly advantageous embodiment, these amounts are amplified by a multiplicative factor which is lower for neurons making higher quantitative contributions to the quality than for neurons making lower quantitative contributions to the quality. Neurons having a currently lower performance are thus subjected to more intense learning steps with the goal of thereby actively improving the performance, similar to tutoring lessons. For example, the iteration steps of weights Θₜ^{k} are able to be carried out according to the rule

wₜ₊₁^{k}=wₜ^{k}−α∇^{k}(1−Mₜ^{k}).

In a further, particularly advantageous embodiment of the present invention, neurons are temporarily deactivated during training at a probability that is greater for neurons making greater quantitative contributions to the quality than for neurons making lower quantitative contributions to the quality.

This measure is also used for the selective boosting of neurons whose quantitative contributions to the quality are presently low. The temporary deactivation of precisely the high-performing neurons forces the ANN to involve also the weaker neurons in the generation of the ultimate output variables. To that effect, these weaker neurons also receive more feedback from the comparison of the output variables to the “ground truth” in the form of the learning values for the output variables. Their performance thus tends to improve in the final analysis. The situation is comparable to conducting classroom teaching in a class featuring different levels of proficiency. If questions by the teacher are always addressed only to the strong students, then the weaker students do not learn anything new, which creates a more solid or possibly even growing gap between the strong and the weak students.

As a further consequence, this measure also makes the ANN more robust with respect to an unavailability of the high-performance neurons because the ANN trains precisely for situations such as this by the temporary deactivation.

For example, the dropout tensor Dₜ₋ₙ^{k} for t>0 is able to be sampled via a Bernoulli function. This function in turn depends on the activation quality Mₜ^{k} with regard to a previous iteration step. In this way, probabilities p^{k} that neurons of a layer k are activated result as

p^{k}=1−Mₜ₋₍ₙ₊₁₎^{k}.

In a further, particularly advantageous embodiment of the present invention, neurons making greater quantitative contributions to the quality are allocated higher significance values in the ANN than neurons making lower quantitative contributions to the quality. The significance value, for example, may manifest itself by the weight at which outputs of the affected neurons are taken into account or by whether the neurons are activated in the first place.

This example embodiment may particularly be used to compress the ANN to the relevant part. To this end, neurons whose quantitative contributions to the quality satisfy a predefined criterion are able to be deactivated in the ANN. The criterion can be formulated in the form of an absolute criterion, for instance, such as a threshold value. However, the criterion can also be formulated as a relative criterion such as a deviation of the quantitative contributions to the quality from the quantitative contributions of other neurons or from a summarizing statistic thereof. A summarizing statistic may include a mean, a median and/or standard deviations, for instance.

In contrast to neurons whose outputs are simply underweighted, deactivated neurons are able to be saved completely when the fully trained ANN is implemented on hardware. The more compressed the ANN, the fewer hardware resources are required for the ultimate implementation.

The same applies when unimportant connections between neurons are deactivated in the ANN. Each one of these connections costs additional computing time in the inference while the ANN is in operation because the output of the neuron must be multiplied by the weight of the connection at one end of the connection and then becomes part of the activation of the neuron at the other end of the connection. If the weight of the connection differs from zero, then these computing operations become necessary and always take up the same amount of time no matter how close the weight is to zero and how small an effect of the consideration of this connection ultimately has on the output of the ANN. For this reason, in one further, particularly advantageous embodiment, connections between neurons whose weights satisfy a predefined criterion are deactivated in the ANN. Similar to the criterion for the quantitative contributions of neurons, the criterion may be formulated in absolute or relative terms.

In a further particularly advantageous embodiment of the present invention, the number of neurons activated in the ANN and/or in a subregion of the ANN is reduced from a first number to a predefined second number by deactivating neurons that make the least quantitative contributions. In this way, the maximum complexity of the ANN is able to be specified by the used hardware, for example.

The present invention also relates to a method for implementing an ANN on a predefined arithmetic unit. In this method a model of the ANN is trained in a training environment outside the arithmetic unit using the above-described method. Neurons and connections between neurons that are activated at the conclusion of the training are implemented on the arithmetic unit.

The predefined arithmetic unit, for example, may be designed for an installation in a control unit of a vehicle and/or it may be designed for a supply of energy from the onboard electrical system of a vehicle. The available space and thermal budget in the control unit or the available current amount then limit the hardware resources that are available for the inference of the ANN.

In contrast, the training environment may be equipped with considerably more powerful resources. For example, a physical and/or virtual computer having a powerful graphics processor (GPU) is able to be used. This then requires few or even no advance considerations for starting the training; the model should simply have a certain minimum size by which the problem to be solved is likely able to be mapped in an adequate manner.

With the aid of the above-described method, it is possible to ascertain within the training environment which neurons and connections between neurons are important. On that basis, the ANN is able to be compressed for the implementation on the arithmetic unit. As described above, this may also be done directly and automatically within the training environment.

Thus, starting from a predefined arithmetic unit which has hardware resources for a predefined number of neurons, layers of neurons and/or connections between neurons, it is generally possible in an advantageous manner to select a model of the ANN whose number of neurons, layers of neurons and/or connections between neurons exceeds the predefined number. The compression ensures that the trained ANN ultimately fits the predefined hardware. In this context an attempt is made that the particular neurons and connections between neurons that are ultimately implemented on the hardware are also the most important for the inference during the operation of the ANN.

The present invention also relates to a further method. In this method, in accordance with an example embodiment of the present invention, an artificial neural network, ANN, is first trained using the above-described method for training and/or implemented by the above-described method for an implementation on an arithmetic unit. The ANN is subsequently operated in that an input variable or a plurality of input variables is conveyed to the ANN. Depending on the output variables supplied by the ANN, a vehicle, a robot, a quality control system and/or a system for monitoring a region on the basis of sensor data is/are actuated.

In particular an ANN that is developed as a classifier and/or regressor for physical measuring data recorded by at least one sensor is able to be selected in the above-described method. It then allows for a meaningful evaluation of the physical measuring data by the artificial intelligence that can be generalized for many situations even in applications in which only limited hardware, a limited energy quantity or limited installation space is available. For instance, the sensor may be an imaging sensor, a radar sensor, a lidar sensor, or an ultrasonic sensor.

The present method may in particular be implemented entirely or partially in software, which provides the direct customer benefit that an ANN supplies better results for the inference in its operation in relation to the hardware expenditure and the energy consumption. The present invention therefore also relates to a computer program having machine-readable instructions that when executed on a computer and/or on a control unit and/or on an embedded system, induces the computer, the control unit and/or the embedded system to carry out one of the described methods. Control units and embedded systems may thus be considered computers at least in the sense that their behavior is entirely or partially characterized by a computer program. As a consequence, the term ‘computer’ includes a variety of devices for the processing of predefinable calculation rules. These calculation rules may exist in the form of software or hardware or also in a mixed form of software and hardware.

In the same way, the present invention also relates to a machine-readable data carrier or a download product that includes the computer program. A download product is a digital product that is transmittable via a data network, i.e. downloadable by a user of the data network, and is offered for sale by an online store for an immediate download, for example.

In addition, a computer may be equipped with the computer program, the machine-readable data carrier or with the download product and/or be developed in another manner specifically for carrying out one of the described methods. Such a specific device, for example, can be realized using field-programmable gate systems (FPGAs) and/or application-specific integrated switching circuits (ASICs).

Additional measures improving the present invention will be shown in greater detail in the following text together with the description of the preferred exemplary embodiments of the present invention with the aid of figures.

### BRIEF DESCRIPTION OF THE DRAWINGS

FIG. 1 shows an exemplary embodiment of method 100 for training an ANN 1, in accordance with the present invention.

FIG. 2 shows an exemplary embodiment of method 200 for implementing an ANN 1 on an arithmetic unit 4, in accordance with the present invention.

FIG. 3 shows an exemplary compression of an ANN 1, in accordance with the present invention.

### DETAILED DESCRIPTION OF EXAMPLE EMBODIMENTS

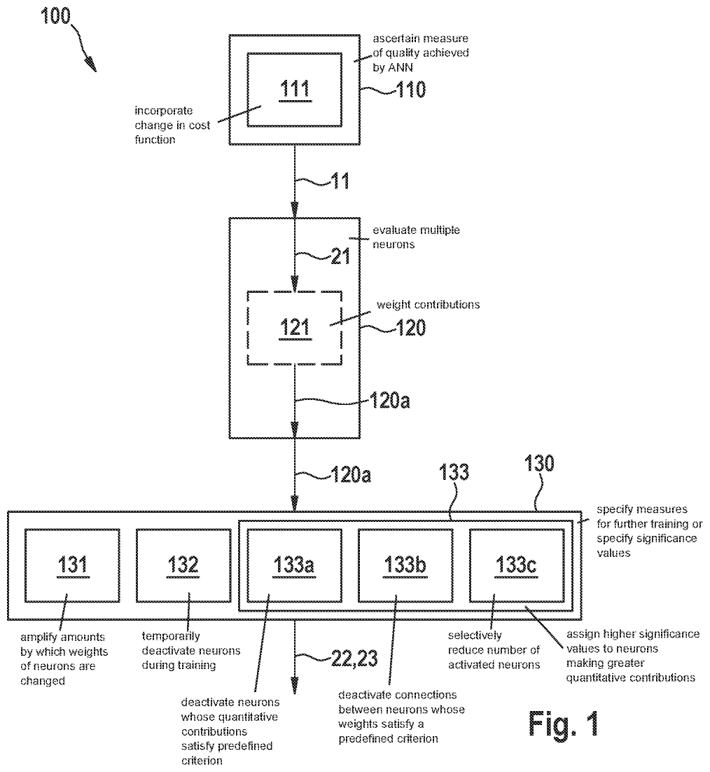

FIG. 1 shows an exemplary embodiment of method 100. Method 100 is embedded in the conventionally conducted training of ANN 1, which, among other things, includes the application of ANN 1 with learning values for input variables, the comparison of the output variables generated by ANN 1 with the learning values for the output variables, and also the change of the parameters within the ANN according to the stipulations of the cost function. For reasons of clarity, these steps are not shown in FIG. 1.

In step 110, a measure of quality 11 achieved by the ANN within a predefined time period in the past is ascertained at a random point in time and in a random phase of the training process. According to block 111, in particular the change in the cost function used when ANN 1 is trained is able to be incorporated into the measure of quality 11.

In step 120, multiple neurons 2 are evaluated based on a measure of their respective quantitative contributions 21 to previously ascertained quality 11. According to block 121, these contributions 21 may in particular be weighted proportionately more highly the more recently the contributions 21 were rendered. For instance, these contributions 21 are able to be ascertained from the activation quality Mₜ^{k} described above in detail. In particular, values of activation quality Mₜ^{k} may be directly used as contributions 21.

Based on evaluations 120a produced in the process, measures 22 for the further training of evaluated neurons 2 and/or significance values 23 of these evaluated neurons 2 in ANN 1 are specified in step 130.

More specifically, according to block 131, amounts by which the weights of neurons 2 are changed in at least one training step can be amplified by a multiplicative factor, which is lower for neurons 2 that contribute more to quality 11 than for neurons that contribute less to quality 11.

According to block 132, neurons 2 are able to be temporarily deactivated during the training, the probability of such a deactivation being greater for neurons 2 making greater quantitative contributions 21 to quality 11 than for neurons 2 making lower quantitative contributions 21 to quality 11.

According to block 133, neurons 2 making greater quantitative contributions 21 to quality 11 have been assigned higher significance values in ANN 1 than neurons 2 making lower quantitative contributions 21.

For example, according to sub-block 133a, this may include a deactivation of neurons 2 whose quantitative contributions 21 satisfy a predefined criterion. It is also possible according to sub-block 133b that connections 25 between neurons 2 whose weights satisfy a predefined criterion are deactivated. According to sub-block 133c, the number of activated neurons is able to be selectively reduced to a predefined number in that neurons 2 featuring the lowest quantitative contributions 21 to quality 11 are deactivated.

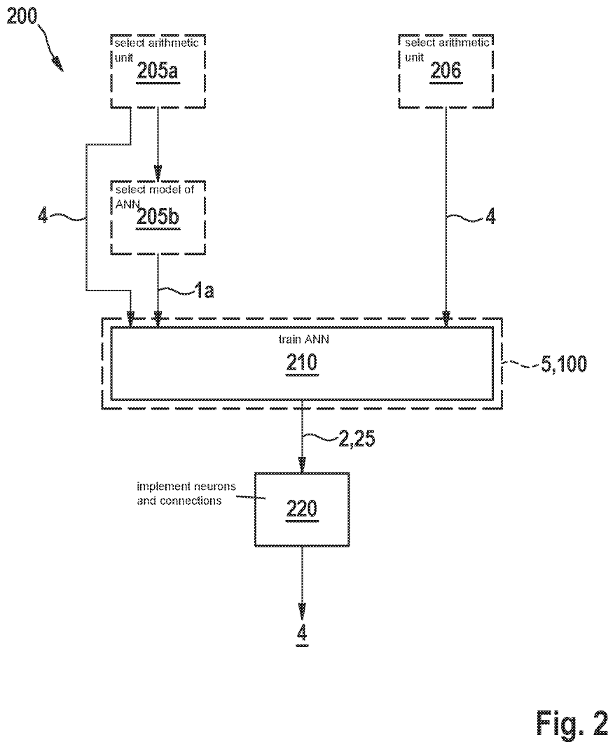

FIG. 2 shows an exemplary embodiment of method 200 for implementing ANN 1 on a predefined arithmetic unit 4. In optional step 205a, an arithmetic unit 4 having limited resources with regard to the number of neurons 2, layers 3a, 3b with neurons 2, and/or connections 25 between neurons 2 is able to be selected in advance. Model 1a of the ANN can then be selected so that it has a number of neurons 2, layers 3a, 3b or connections 25 that lies above the respective limit of arithmetic unit 4. According to optional step 206, an arithmetic unit 4 which is designed for an installation in a control unit of a vehicle and/or for a supply of energy from the onboard electrical system of a vehicle is able to be selected, in particular.

In step 210, ANN 1 is trained according to the above-described method 100. Neurons 2 and connections 25 between neurons 2 activated upon conclusion of training 210 are implemented on arithmetic unit 4 in step 220. As described above, the compression during training 210 makes it possible for an ANN that is too large for limited hardware resources to be “made to fit”. If this proves insufficient, then a further selection of neurons 2, layers 3a, 3b and/or connections 25 may be made after the conclusion of training 210.

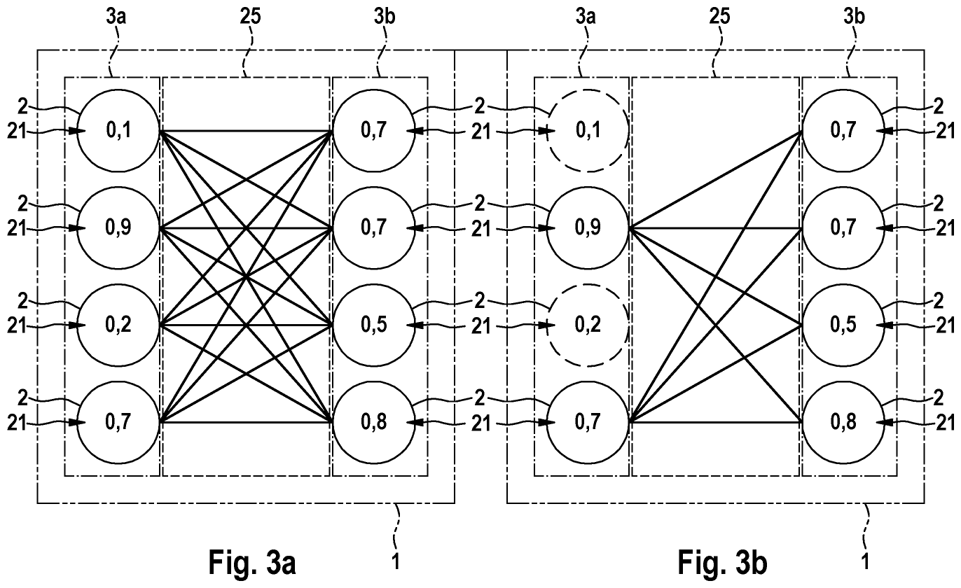

FIG. 3 shows the effect of the compression using an exemplary ANN 1. This ANN 1 includes two layers 3a and 3b, each having four neurons 2 whose exemplary quantitative contributions 21 to quality 11 of ANN 1 are indicated as totals in each case.

In the state illustrated in FIG. 3a, the two layers 3a and 3b are still fully networked with each other, which means that each neuron 2 of first layer 3a is connected to each neuron 2 of second layer 3b, and all neurons 2 are still active.

In the state shown in FIG. 3b, the rule was applied according to which all neurons 2 having quantitative contributions 21 of less than 0.5 as well as connections 25 leading to these neurons 2 will be deactivated. The neurons circled by dashed lines in first layer 3a were sacrificed to this rule. As a result, the number of still active connections 25 was halved from 16 to eight, which correspondingly reduces the processing requirement for the inference while ANN 1 is in operation.

1-18. (canceled)

19. A method for training an artificial neural network (ANN), which has a multitude of neurons, the method comprising the following steps:
ascertaining a measure of a quality that the ANN and/or a subregion of the ANN has achieved overall within a time period in the past;
evaluating one or more of the neurons based on a measure of their respective quantitative contributions to the ascertained quality; and
specifying measures by which the evaluated neurons are trained in a further course of the training and/or significance values of the evaluated neurons in the ANN, based on the evaluations of the neurons.

20. The method as recited in claim 19, wherein the measure of the quality includes a measure of a training progress of the ANN, and/or a measure of a capacity utilization of the neurons of a layer or of another subregion of the ANN, and/or a measure of a capacity utilization of the neurons of the ANN as a whole.

21. The method as recited in claim 19, wherein the measure of the quality is evaluated as a weighted or unweighted sum of quantitative contributions of individual neurons.

22. The method as recited in claim 19, wherein a change of a cost function, to an optimization of which the training of the ANN is directed, over the past time period is taken into account in the measure of the quality.

23. The method as recited in claim 19, wherein quantitative contributions of neurons to the quality are weighted proportionately more highly the more recently in time the contributions were rendered.

24. The method as recited in claim 19, wherein amounts by which weights that are allocated to neurons in the ANN are changed in at least one training step are amplified by a multiplicative factor that is lower for neurons making greater quantitative contributions than for neurons making lower quantitative contributions.

25. The method as recited in claim 19, wherein neurons are temporarily deactivated during the training at a probability that is greater for neurons making greater quantitative contributions than for neurons making lower quantitative contributions.

26. The method as recited in claim 19, wherein the past time period includes at least one epoch of the training.

27. The method as recited in claim 19, wherein neurons making greater quantitative contributions are allocated higher significance values in the ANN than neurons making lower quantitative contributions.

28. The method as recited in claim 27, wherein neurons whose quantitative contributions satisfy a predefined criterion are deactivated in the ANN.

29. The method as recited in claim 27, wherein connections between neurons whose weights satisfy a predefined criterion are deactivated in the ANN.

30. The method as recited in claim 27, wherein a number of neurons activated in the ANN and/or in a subregion of the ANN is reduced from a first number to a predefined second number by deactivating neurons that make the least quantitative contributions.

31. A method for implementing an artificial neural network (ANN) on a predefined arithmetic unit, the method comprising the following steps:
training a model of the ANN in a training environment outside the arithmetic unit by:
ascertaining a measure of a quality that the ANN and/or a subregion of the ANN has achieved overall within a time period in the past,
evaluating one or more of the neurons based on a measure of their respective quantitative contributions to the ascertained quality, and
specifying measures by which the evaluated neurons are trained in a further course of the training and/or significance values of the evaluated neurons in the ANN, based on the evaluations of the neurons;
implementing on the arithmetic unit neurons and connections between neurons that are activated at a conclusion of the training.

32. The method as recited in claim 31, wherein the arithmetic unit is selected that has hardware resources for a predefined number of neurons, and/or layers of neurons and/or connections between neurons, and a model of the ANN is selected whose number of neurons, and/or layers of neurons and/or connections between neurons exceeds the predefined number.

33. A method, comprising:
training an artificial neural network (ANN) by
ascertaining a measure of a quality that the ANN and/or a subregion of the ANN has achieved overall within a time period in the past,
evaluating one or more of the neurons based on a measure of their respective quantitative contributions to the ascertained quality, and
specifying measures by which the evaluated neurons are trained in a further course of the training and/or significance values of the evaluated neurons in the ANN, based on the evaluations of the neurons;
operating the ANN in that an input variable or a plurality of input variables is conveyed to the ANN; and
depending on output variables supplied by the ANN, actuating a vehicle, and/or a robot, and/or a quality control system and/or a system for monitoring a region based on sensor data.

34. A non-transitory machine-readable data carrier on which is stored a computer program for training an artificial neural network (ANN), which has a multitude of neurons, the computer program, when executed by a computer and/or control unit and/or embedded system, causes the computer and/or control unit and/or embedded system. the perform the following steps:
ascertaining a measure of a quality that the ANN and/or a subregion of the ANN has achieved overall within a time period in the past;
evaluating one or more of the neurons based on a measure of their respective quantitative contributions to the ascertained quality; and
specifying measures by which the evaluated neurons are trained in a further course of the training and/or significance values of the evaluated neurons in the ANN, based on the evaluations of the neurons.

35. A computer configured to train an artificial neural network (ANN), which has a multitude of neurons, the computer configured to:
ascertain a measure of a quality that the ANN and/or a subregion of the ANN has achieved overall within a time period in the past;
evaluate one or more of the neurons based on a measure of their respective quantitative contributions to the ascertained quality; and
specify measures by which the evaluated neurons are trained in a further course of the training and/or significance values of the evaluated neurons in the ANN, based on the evaluations of the neurons.
